(19) United States
(12) Patent Application Publication
(10) Pub. No.: US 2014/0195514 A1
(43) Pub. Date: Jul. 10, 2014

(54) UNIFIED INTERFACE FOR QUERYING DATA IN LEGACY DATABASES AND CURRENT DATABASES

(71) Applicant: DROPBOX, INC., San Francisco, CA (US)

(72) Inventor: David Stein, San Francisco, CA (US)

(73) Assignee: Dropbox, Inc., San Francisco, CA (US)

(21) Appl. No.: 13/737,322

(22) Filed: Jan. 9, 2013

(51) Int. Cl. G06F 17/30

(52) U.S. Cl. CPC G06F 17/30554
USPC 707/722

(57) ABSTRACT

Systems, methods, and computer-readable storage media for a unified interface for querying data that may reside in one of a legacy database or a current database. Rather than performing a risky or potentially time-consuming database migration, new data is stored in the current database and the existing data remains in the legacy database. Users submit database queries through a query interface that hides or abstracts the complexity of the current and legacy databases from the users. Thus, while two separate databases exist on the back end, users do not know and do not need to know of that complexity when submitting a database query. The query interface can determine which database contains the requested data, convert the database query to the appropriate format, if necessary, for that database, and execute the converted query.

### TECHNICAL FIELD

The present technology pertains to managing database queries and more specifically pertains to simplifying access to incompatible databases that are concurrently in use.

### BACKGROUND

Databases are useful tools in virtually every business. Different types of databases have different performance, storage, usability, reliability, price, and other characteristics. A database administrator will often select a particular database type based on current and anticipated data storage needs, other business requirements, available resources, or even personal preference or personal familiarity of the database administrator. However, as data storage needs exceed what was originally anticipated, as additional resources become available, as the database administrator changes, or as new database technology is developed, a business or other organization may switch from one database type to another database type.

Such transitions can be handled in a number of ways. In one approach, the entire contents of the existing or legacy database are migrated to the new or current database. While this approach results in a single, simple database interface, this can lead to data translation problems and may lead to down time while the data is being migrated. In another approach, the current database and the legacy database co-exist side by side, but this solution introduces complexity in retrieving data from the databases. Database transitions are difficult for a business or organization and can have potentially extremely significant impacts on how the business or organization operates.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can allow for a simpler, unified interface for querying data that may reside in one of a legacy database or a current database. In one example, a business starts out using a first database, and populates the first database with a significant amount of data. At some point, the business decides to transition to a second database of a different type, such as if the data storage needs exceed the capabilities of the first database or if the second database offers enhanced performance. The second database is the current database, and the first database is the legacy database. Rather than performing a risky or potentially time-consuming database migration, new data is stored in the current database and the existing data remains in the legacy database. Users submit database queries through a query interface that hides or abstracts the complexity of the current and legacy databases from the users. Thus, while two separate databases exist on the back end, users do not know and do not need to know of that complexity when submitting a database query. The query interface can determine which database contains the requested data, convert the database query to the appropriate format, if necessary, for that database, and execute the converted query. In some variations, the database query may cover data stored in both databases, so a single database query can be converted to two or more queries for different databases.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 illustrates an example system architecture for providing a unified interface for querying a legacy database and a current database;

FIG. 3 illustrates a first example flow diagram for selectively translating queries;

FIG. 4 illustrates a second example flow diagram for executing queries submitted via a unified interface for data residing in one of a legacy database or a current database;

FIG. 5A shows a conventional system bus computing system architecture; and

FIG. 5B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The present disclosure addresses the difficulties of migrating between database types. A first or initial database type is referred to as a legacy database, and a second or replacement database type is referred to as a current database. Database types can include local, distributed, client-server, embedded, or network-based databases. The legacy database and the current database can exist concurrently, and can both serve queries. However, in many cases the legacy database and the current database use different query languages, or have different interfaces, different physical hardware, and so forth. A translation layer processes user requests for information in the legacy or current databases, and converts the user requests submitted to the translation layer to type-specific queries. In one example of how such a legacy and current database configuration can occur, a business sets up an initial configuration for a small database, and the needs of the business outgrew the capacity of the small database. Thus, the business relegates the small database to be a legacy database, and establishes a new database as the current database.

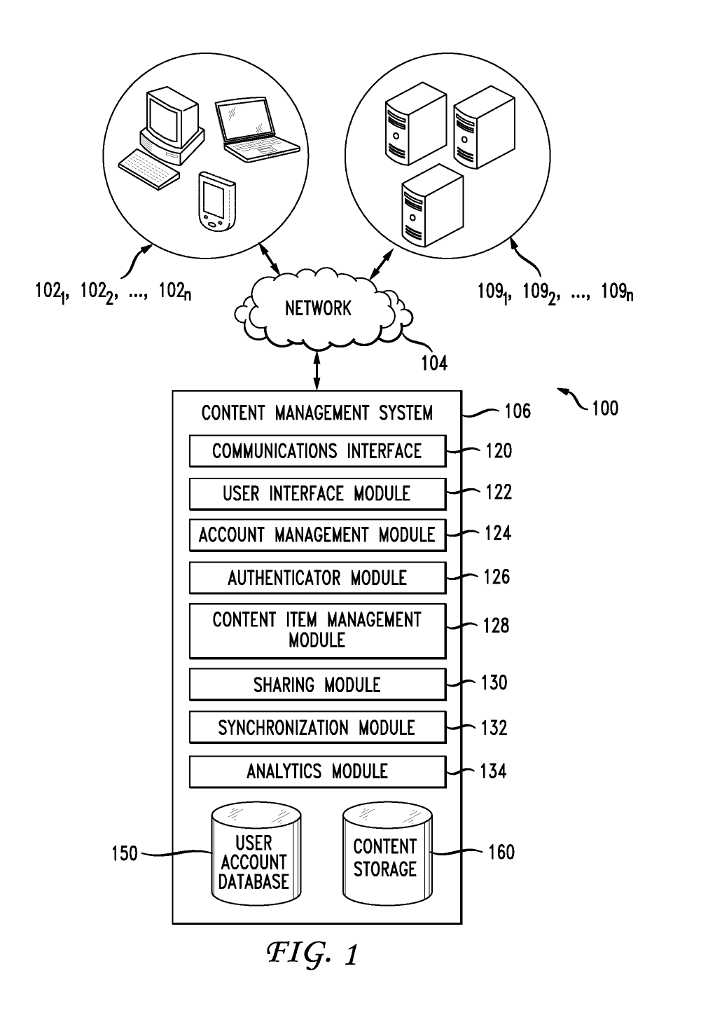

An exemplary system configuration 100 is shown in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a user can interact with content management system 106 through client devices 102₁, 102₂, . . . , 102ₙ (collectively “102”) connected to network 104 by direct and/or indirect communication. Content management system 106 can support connections from a variety of different client devices, such as desktop computers; mobile computers; mobile communications devices, e.g. mobile phones, smart phones, tablets; smart televisions; set-top boxes; and/or any other network enabled computing devices. Client devices 102 can be of varying type, capabilities, operating systems, etc. Furthermore, content management system 106 can concurrently accept connections from and interact with multiple client devices 102.

A user can interact with content management system 106 via a client-side application installed on client device 102ᵢ. In some embodiments, the client-side application can include a content management system specific component. For example, the component can be a stand-alone application, one or more application plug-ins, and/or a browser extension. However, the user can also interact with content management system 106 via a third-party application, such as a web browser, that resides on client device 102, and is configured to communicate with content management system 106. In either case, the client-side application can present a user interface (UI) for the user to interact with content management system 106. For example, the user can interact with the content management system 106 via a client-side application integrated with the file system or via a webpage displayed using a web browser application.

Content management system 106 can make it possible for a user to store content, as well as perform a variety of content management tasks, such as retrieve, modify, browse, and/or share the content. Furthermore, content management system 106 can make it possible for a user to access the content from multiple client devices 102. For example, client device 102, can upload content to content management system 106 via network 104. The content can later be retrieved from content management system 106 using the same client device 102, or some other client device 102.

To facilitate the various content management services, a user can create an account with content management system 106. The account information can be maintained in user account database 150. User account database 150 can store profile information for registered users. In some cases, the only personal information in the user profile can be a username and/or email address. However, content management system 106 can also be configured to accept additional user information.

User account database 150 can also include account management information, such as account type, e.g. free or paid; usage information, e.g. file edit history; maximum storage space authorized; storage space used; content storage locations; security settings; personal configuration settings; content sharing data; etc. Account management module 124 can be configured to update and/or obtain user account details in user account database 150. The account management module 124 can be configured to interact with any number of other modules in content management system 106.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 160. Content storage 160 can be a storage device, multiple storage devices, or a server. Alternatively, content storage 160 can be a cloud storage provider or network storage accessible via one or more communications networks. Content management system 106 can hide the complexity and details from client devices 102 so that client devices 102 do not need to know exactly where the content items are being stored by content management system 106. In one variation, content management system 106 can store the content items in the same folder hierarchy as they appear on client device 102ᵢ. However, content management system 106 can store the content items in its own order, arrangement, or hierarchy. Content management system 106 can store the content items in a network accessible storage (SAN) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various accounts, folders, or groups. The metadata for a content item can be stored as part of the content item or can be stored separately. In one variation, each content item stored in content storage 160 can be assigned a system-wide unique identifier.

Content storage 160 can decrease the amount of storage space required by identifying duplicate files or duplicate segments of files. Instead of storing multiple copies, content storage 160 can store a single copy and then use a pointer or other mechanism to link the duplicates to the single copy. Similarly, content storage 160 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 106 can be configured to support automatic synchronization of content from one or more client devices 102. The synchronization can be platform agnostic. That is, the content can be synchronized across multiple client devices 102 of varying type, capabilities, operating systems, etc. For example, client device 102, can include client software, which synchronizes, via a synchronization module 132 at content management system 106, content in client device 102ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 106. Conversely, the background process can identify content that has been updated at content management system 106 and synchronize those changes to the local folder. The client software can provide notifications of synchronization operations, and can provide indications of content statuses directly within the content management application. Sometimes client device 102, may not have a network connection available. In this scenario, the client software can monitor the linked folder for file changes and queue those changes for later synchronization to content management system 106 when a network connection is available. Similarly, a user can manually stop or pause synchronization with content management system 106.

A user can also view or manipulate content via a web interface generated and served by user interface module 122. For example, the user can navigate in a web browser to a web address provided by content management system 106. Changes or updates to content in the content storage 160 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 106 can include a communications interface 120 for interfacing with various client devices 102, and can interact with other content and/or service providers 109₁, 109₂, . . . , 109ₙ (collectively “109”) via an Application Programming Interface (API). Certain software applications can access content storage 160 via an API on behalf of a user. For example, a software package, such as an app on a smartphone or tablet computing device, can programmatically make calls directly to content management system 106, when a user provides credentials, to read, write, create, delete, share, or otherwise manipulate content. Similarly, the API can allow users to access all or part of content storage 160 through a web site.

Content management system 106 can also include authenticator module 126, which can verify user credentials, security tokens, API calls, specific client devices, and so forth, to ensure only authorized clients and users can access files. Further, content management system 106 can include analytics module 134 that can track and report on aggregate file operations, user actions, network usage, total storage space used, as well as other technology, usage, or business metrics. A privacy and/or security policy can prevent unauthorized access to user data stored with content management system 106.

Content management system 106 can include sharing module 130 for managing sharing content publicly or privately. Sharing content publicly can include making the content item accessible from any computing device in network communication with content management system 106. Sharing content privately can include linking a content item in content storage 160 with two or more user accounts so that each user account has access to the content item. The sharing can be performed in a platform agnostic manner. That is, the content can be shared across multiple client devices 102 of varying type, capabilities, operating systems, etc. The content can also be shared across varying types of user accounts.

In some embodiments, content management system 106 can include a content item management module 128 for maintaining a content directory. The content directory can identify the location of each content item in content storage 160. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 106 can use the content path to present the content items in the appropriate folder hierarchy.

A content entry can also include a content pointer that identifies the location of the content item in content storage 160. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 130 can be configured to add a user account identifier to the content entry associated with the content item, thus granting the added user account access to the content item. Sharing module 130 can also be configured to remove user account identifiers from a content entry to restrict a user account's access to the content item.

To share content publicly, sharing module 130 can be configured to generate a custom network address, such as a uniform resource locator (URL), which allows any web browser to access the content in content management system 106 without any authentication. To accomplish this, sharing module 130 can be configured to include content identification data in the generated URL, which can later be used to properly identify and return the requested content item. For example, sharing module 130 can be configured to include the user account identifier and the content path in the generated URL. Upon selection of the URL, the content identification data included in the URL can be transmitted to content management system 106 which can use the received content identification data to identify the appropriate content entry and return the content item associated with the content entry.

In addition to generating the URL, sharing module 130 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 130 can be configured to change the value of the flag to 1 or true after generating a URL to the content item.

In some embodiments, sharing module 130 can also be configured to deactivate a generated URL. For example, each content entry can also include a URL active flag indicating whether the content should be returned in response to a request from the generated URL. For example, sharing module 130 can be configured to only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing module 130 can reactivate the URL by again changing the value of the URL active flag to 1 or true. A user can thus easily restore access to the content item without the need to generate a new URL.

While content management system 106 is presented with specific components, it should be understood by one skilled in the art, that the architectural configuration of system 106 is simply one possible configuration and that other configurations with more or less components are also possible.

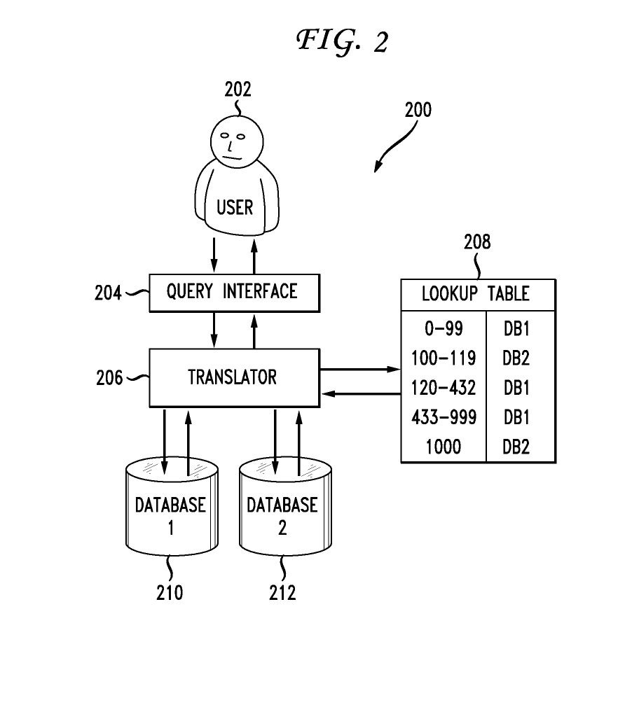

FIG. 2 shows example system architecture 200 for providing a unified interface for querying a legacy database 210 and a current database 212. System architecture 200 can be part of content management system 106. For example, content management system 106 can include multiple databases including both legacy and current databases.

User 202 can submit a query through query interface 204, such as a command line interface, web based interface, or other suitable interface. In a command line interface, a user can manually type in a query either according to a specific structured format or as a natural language query. In a web-based interface, the user can either enter text in to a field in a web page or interact with page elements in a more structured form. For example, a web-based interface can provide a number of fields or menus from which the user can select a type of query, and populate the various fields for that query. The user can select a query for contact information for a single account or a class of accounts. Then the web based interface can generate or display the various fields that the user needs to populate to execute the query, such as an account name, account number, or account category, which pieces of contact information to retrieve, and what format in which to present the results. In one example, the user can interact with some program or application that formulates and submits queries through query interface 204 automatically based on user input. For instance, the query interface can be an Application Programming Interface (API) through which other applications or programs can access the information in both legacy database 210 and current database 212. Query interface 204 can accept queries according to a generic format that is not associated with any specific database type, or can accept queries in one or more other query formats. Query interface 204 can optionally pre-process the query and submit the query to translator 206. Translator 206 can analyze portions of the query to identify indicators of which data is being requested. Translator 206 can refer to a lookup table 208 indicating which database contains the requested data. Then translator 206 can convert the query to the appropriate format for whichever database contains the requested data, and executes the query. Then the query results can be passed back to user 202.

Sometimes results may or may not be located exclusively in a single database. While a query for a single record may very well reside in one database or the other, a query for a range of results may span both legacy database 210 and current database 212. When translator 206 determines that expected results to a single query may be found in both databases 210 and 212, translator 206 can processes the single query and divide that single query into two separate queries, one for legacy database 210 and one for current database 212. Then translator 206 can combine the respective query results, and provide the combined results in response to the single query.

In one variation, translator 206 can refer to a translation table, not shown, that provides query formats or query templates for the various database types. Such a translation table can be incorporated directly in to translator 206. As the number and type of databases expands, the translation table and lookup table 208 can be updated with the relevant information for any new database types. In one example, the system can add additional databases, so that more than two databases of different types are accessible through query interface 204 and translator 206. Thus, this approach can assist in smoothing multiple database migrations with only minimal added complexity, and with most of that complexity being located in lookup table 208.

In one aspect, databases 210 and 212 can be accessed only through query interface 204 and translator 206, but in other aspects, databases 210 and 212 can be directly accessible in addition to accessible through query interface 204 and translator 206. This particular arrangement can be implemented as a temporary measure that provides a smoother transition period while converting, migrating, and testing the legacy database. For example, this split arrangement between current and legacy databases can be used while current database 212 is populated with data from legacy database 210, or while a replacement database is being prepared. Then, when the conversion is complete and ready for use, query interface 204 can be switched to the replacement database or exclusively to current database 212. Although example system architecture 200 includes legacy database 210 and current database 212, one of ordinary skill in the art will recognize that any device or combination of devices capable of storing data and returning data in response to queries can utilize the disclosed technology.

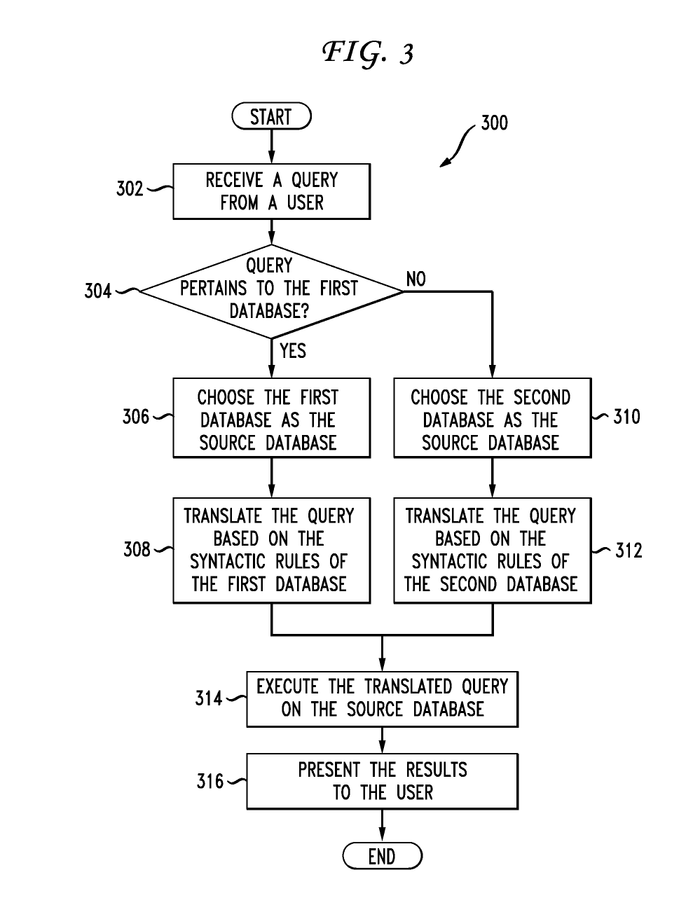

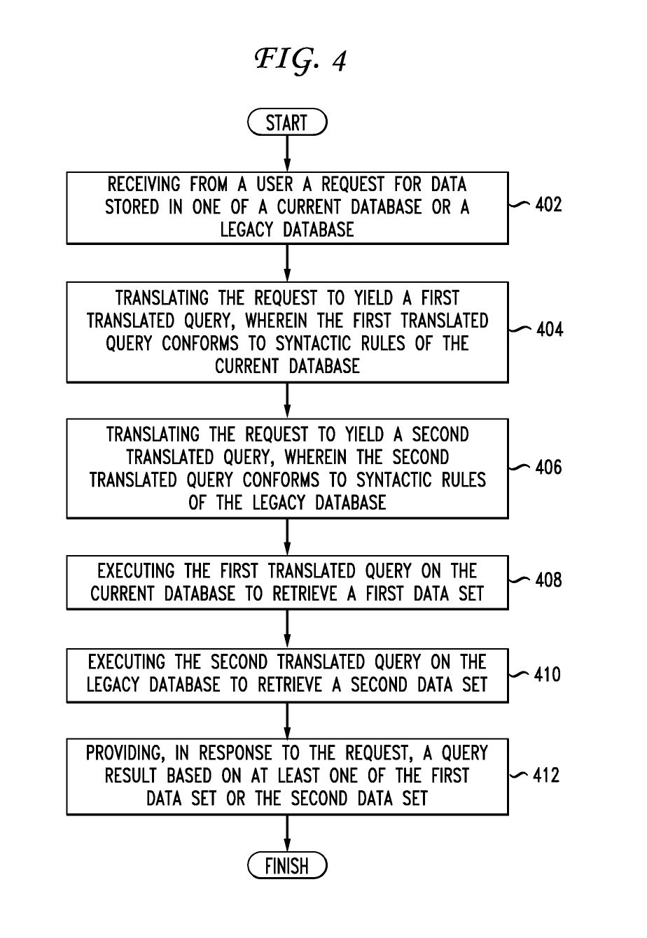

Having disclosed some system components and concepts, the disclosure now turns to the example flow diagrams illustrated in FIGS. 3 and 4. For the sake of clarity, the methods are described in terms of an example system 200, as shown in FIG. 2, configured to practice the methods depicted in the flow diagrams. The steps outlined herein are examples and can be implemented in any combination thereof, including combinations that exclude, add, or modify certain steps.

FIG. 3 shows a first example flow diagram for selectively translating queries. The system can receive a query from a user (302) for data contained in one of a first, or legacy, database or a second, or current, database. In one aspect, the query may not directly specify either the first database or the second database. The first database and the second database can be separate and incompatible with each other, but may be compatible one with another but hosted on different hardware or at a different network address, for example. The query can follow syntactic rules that are compatible with one of the first database or the second database, or syntactic rules that are incompatible with the first database or the second database. The first database or the second database can be designed for data-intensive distributed applications that support running applications on large clusters of commodity hardware.

The system can determine whether the query pertains to the first database (304), such as by examining which data the query is requesting, and using that data in a lookup table. The lookup or routing table can indicate which ranges of data reside in the first database and which ranges of data reside in the second database. In one variation, the system can populate or update ranges in the lookup table by prompting the user or an administrator to approve or reject a query, to provide feedback or modifications to a query, and so forth. The system can examine the results of a query, and update the lookup table if the results are not from the correct database.

The system can select, based on information requested in the query, one of the first database or the second database as a source database from which to service the query. For example, the system can select the first database as the source database (306) and translate the query based on syntactic rules of the first database to yield a translated query (308). Alternatively, the system can select the second database as the source database (310) and translate the query based on syntactic rules of the second database to yield a translated query (312). The system can execute or perform, or causes to be executed or performed, the translated query on the source database to retrieve a data set (314). The system can present to the user a query result based on the data set (316), such as through a dashboard user interface. A dashboard user interface can allows a user to select a query type, and provide specific details for the query without requiring the user to enter a query in a specific database query format. A dashboard user interface can be more user friendly for users who are unfamiliar with structured query languages. While processing queries, the system can migrate data from the first database to the second database as part of a background process, and update the routing table based on which data was migrated from the first database to the second database.

FIG. 4 illustrate a second example flow diagram for executing queries submitted via a unified interface for data residing in one of a legacy database or a current database. In this flow diagram, the system does not use a lookup table, but instead translates the query to both formats for both the legacy database and the current database, and attempts to perform the query on both databases. The system can then return only the query results that are meaningful or that are non-null.

In this example, the system can receive from a user a request for data stored in one of a current database or a legacy database (402). The request can be formed according to a set of generic database syntactic rules that does not correspond to either the current or legacy databases. The system can translate the request to yield a first translated query, wherein the first translated query conforms to syntactic rules of the current database (404), and translate the request to yield a second translated query, wherein the second translated query conforms to syntactic rules of the legacy database (406). The system can execute the first translated query on the current database to retrieve a first data set (408) and execute the second translated query on the legacy database to retrieve a second data set (410). One data set will be meaningful and one will be either empty, null, or nonsensical. The system can perform a data type check or other verification to determine which data set to return. The system can then provide a query result, in response to the request, based on at least one of the first data set or the second data set (412).

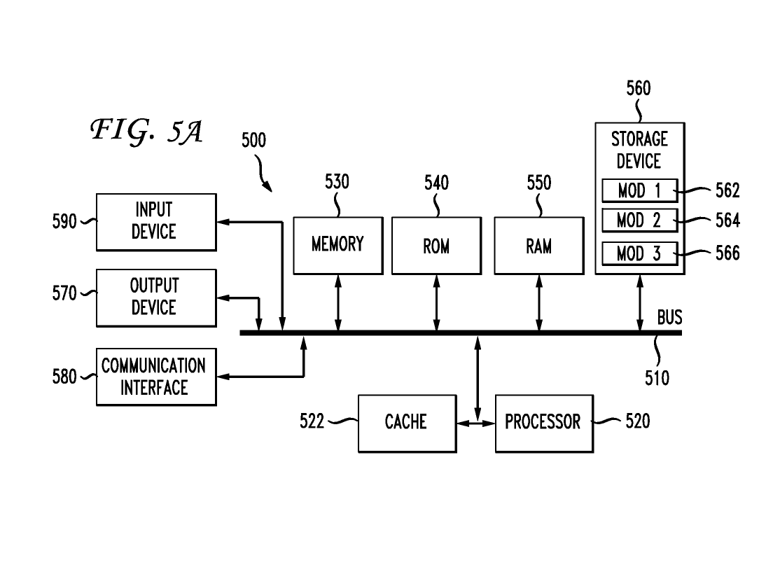

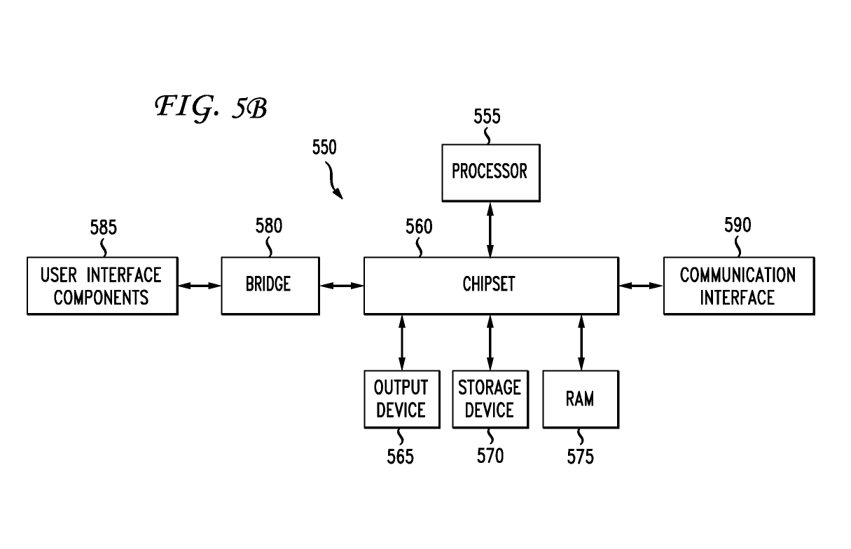

FIG. 5A, and FIG. 5B show exemplary possible system embodiments. The more appropriate embodiment will be apparent to those of ordinary skill in the art when practicing the present technology. Persons of ordinary skill in the art will also readily appreciate that other system embodiments are possible.

FIG. 5A shows a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B shows a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving a query from a user for data contained in one of a first database or a second database, wherein the query does not directly specify either the first database or the second database, and wherein the first database and the second database are separate and incompatible with each other;
selecting, based on information requested in the query, one of the first database or the second database as a source database from which to service the query;
translating, via a processor, the query based on syntactic rules of the source database to yield a translated query;
executing the translated query on the source database to retrieve a data set; and
presenting to the user a query result based on the data set.

2. The method of claim 1, wherein the query follows syntactic rules that are compatible with one of the first database or the second database.

3. The method of claim 1, wherein the query follows syntactic rules that are incompatible with the first database or the second database.

4. The method of claim 1, wherein the first database is a legacy database and the second database is a current database.

5. The method of claim 1, wherein the source database is selected based on a routing table that indicates which ranges of data reside in the first database and which ranges of data reside in the second database.

6. The method of claim 5, further comprising:
migrating data from the first database to the second database as part of a background process; and
updating the routing table based on which data was migrated from the first database to the second database.

7. The method of claim 1, further comprising receiving from an administrator one of approval or rejection of the query, and authorizing execution of the query only upon approval by the administrator.

8. The method of claim 1, wherein the query result is presented via a dashboard user interface.

9. A system comprising:
a processor; and
a non-transitory computer-readable storage medium storing instructions which, when executed by the processor, cause the processor to perform a method comprising:
receiving from a user a request for data stored in one of a current database or a legacy database;
translating the request to yield a first translated query, wherein the first translated query conforms to syntactic rules of the current database;
translating the request to yield a second translated query, wherein the second translated query conforms to syntactic rules of the legacy database;
executing the first translated query on the current database to retrieve a first data set;
executing the second translated query on the legacy database to retrieve a second data set; and
providing, in response to the request, a query result based on at least one of the first data set or the second data set.

10. The system of claim 9, wherein the request is formed according to a set of generic database syntactic rules.

11. The system of claim 9, wherein one of the first data set or the second data set is an empty data set.

12. The system of claim 9, wherein the request follows syntactic rules that are incompatible with the first database or the second database.

13. The system of claim 9, wherein the non-transitory computer-readable storage medium stores additional instructions which, when executed by the processor, cause the processor to perform the method further comprising:
migrating data from the legacy database to the current database in a background process.

14. The system of claim 9, wherein the non-transitory computer-readable storage medium stores additional instructions which, when executed by the processor, cause the processor to perform the method further comprising:
receiving from an administrator one of approval or rejection of the request, and authorizing execution of the request only upon approval by the administrator.

15. The system of claim 9, wherein the request is received via a dashboard user interface.

16. A non-transitory computer-readable storage medium storing instructions which, when executed by a processor, cause the processor to perform a method comprising:
receiving a query from a user for data contained in one of a first database or a second database, wherein the query does not directly specify either the first database or the second database, and wherein the first database and the second database are separate and incompatible with each other;
selecting, based on information requested in the query, one of the first database or the second database as a source database from which to service the query;
translating the query based on syntactic rules of the source database to yield a translated query;
executing the translated query on the source database to retrieve a data set; and
presenting to the user a query result based on the data set.

17. The non-transitory computer-readable storage medium of claim 16, wherein one of the first database or the second database is designed for data-intensive distributed applications.

18. The non-transitory computer-readable storage medium of claim 16, wherein the query follows syntactic rules that are incompatible with the first database or the second database.

19. The non-transitory computer-readable storage medium of claim 16, wherein the first database is a current database and the second database is a legacy database.

20. The non-transitory computer-readable storage medium of claim 16, wherein the query is received via a dashboard user interface.
